(19) United States
(12) Patent Application Publication
(10) Pub. No.: US 2025/0028575 A1
(43) Pub. Date: Jan. 23, 2025

(54) DATA PROCESSING SYSTEM

(71) Applicant: Arm Limited, Cambridge (GB)

(72) Inventors: Ozgur Tasdizen, Cambridge (GB); David Thomas Garbett, Cambridge (GB)

(21) Appl. No.: 18/355,282

(22) Filed: Jul. 19, 2023

(51) Int. Cl. G06F 9/50; G06F 1/3228; G06F 1/3234; G06F 1/3287

(52) U.S. Cl. CPC G06F 9/5094; G06F 1/3228; G06F 1/3243; G06F 1/3287

(57) ABSTRACT

The present disclosure relates to a data processing resource for performing data processing tasks for a host processor, the data processing resource comprising: control circuitry to receive, from the host processor, a request for the data processor unit to perform a processing job; an iterator unit to process the request and generate a workload comprising one or more tasks for the requested processing job; one or more execution units to perform the one or more tasks, wherein the iterator unit is configured to allocate the one or more tasks to the one or more execution units based on control signals from the control circuitry, wherein the control circuitry is further configured to switch an operation mode of at least one execution unit from a normal operation mode to a reduced operation mode by controlling the iterator unit to reduce an amount of task allocated to the at least one execution unit.

### FIELD OF THE INVENTION

The present technology relates to data processing systems in which a processing resource such as an accelerator (e.g. a graphics processing unit (GPU)) performs processing tasks for a host processor.

### BACKGROUND

In an accelerator, e.g. a GPU, in which an execution unit, e.g. a shader core, of the accelerator processes data for a host processor, a soft stop is sometimes required to allow the execution unit to temporarily stop performing processing tasks. A soft stop is a request for (one or more execution units of) the accelerator to stop operation at the earliest possible opportunity without causing data loss. In contrast, a hard stop is a request to stop at the earliest possible opportunity without locking the system, but can (and typically will) cause data loss. For example, a hard stop may only wait of any outstanding bus transactions to complete but may not wait for tasks that have already started being processed in an execution unit to complete before imposing a stop. In other words, a soft stop is a gentler way of bringing the whole accelerator or an execution unit to a halt. A soft stop may be required when the execution unit is to be powered down, e.g. as part of power management, or when the GPU is acting as a common shared resource in a virtualized environment for a plurality of applications (e.g. games, productivity applications, browsers, etc.) and a context switch is required.

For power management purposes, one or more execution units of the accelerator may sometimes be required to power down. To prepare an execution unit for power down, the number of tasks scheduled for the execution may be restricted and/or outstanding tasks already scheduled for the execution unit may be cleared, then a soft stop is imposed to temporarily stop the execution unit so that the execution unit may be safely powered down.

In a virtualized data processing system, including multiple virtual machines (VMs), in order to provide hardware access to a virtualization aware device, e.g. an accelerator, a hypervisor is usually used to manage the allocation of a number of input/output interfaces to the virtual machines which require access to the resources (e.g. execution units, shader cores) of the accelerator. When there are more virtual machines submitting tasks than the accelerator has capacity to manage simultaneously, e.g. owing to a hardware limit on the number of input/output interfaces, then access to the accelerator may be managed e.g. by an arbiter (a software module) through the hypervisor in a time-shared manner. The hypervisor schedules the submission of tasks received from the virtual machines to the accelerator, for example by using scheduling statistics (information regarding the frequency and duration of tasks submitted to and running on the accelerator) collected from the accelerator, and a context switch is performed at (the execution unit of) the accelerator when access to the accelerator resources is switched from one VM to another VM.

When a context switch is required, processing tasks scheduled for the execution unit must be completed when a soft stop is imposed to allow the context switch to take place. In existing approaches, processing tasks are scheduled for a given execution unit based on its current capacity. When a context switch is required, there may be a large number of processing tasks already scheduled for the execution unit and, as such, a significant amount of time may be required to clear all scheduled tasks to complete a soft stop.

Therefore, there remains scope for improved methods and systems for enabling a soft stop of execution units in data processing systems.

### BRIEF DESCRIPTION OF THE DRAWINGS

Embodiments will now be described, with reference to the accompanying drawings, in which:

FIG. 1 shows schematically an exemplary system comprising a host processor and a processing resource;

FIG. 2 shows an exemplary system overview of a data processing system according to an embodiment;

FIG. 3 shows schematically an embodiment of a data processing system comprising a processing resource acting as a shared resource for a plurality of applications;

FIG. 4 shows an exemplary method of operating a data processing resource to perform data processing tasks;

FIG. 5A shows an exemplary power management flow;

FIG. 5B shows an exemplary power management flow according to an embodiment;

FIG. 6 shows an exemplary operating performance point (OPP) curve; and

FIG. 7 shows another exemplary method of operating a data processing resource to perform data processing tasks.

### DETAILED DESCRIPTION

An aspect of the present technology provides a data processing resource for performing data processing tasks for a host processor, the data processing resource comprising: control circuitry to receive, from the host processor, a request for the data processor unit to perform a processing job; an iterator unit to process the request and generate a workload comprising one or more tasks for the requested processing job; and one or more execution units to perform the one or more tasks, wherein the iterator unit is configured to allocate the one or more tasks to the one or more execution units based on control signals from the control circuitry, wherein the control circuitry is further configured to switch an operation mode of at least one execution unit from a normal operation mode to a reduced operation mode by controlling the iterator unit to reduce an amount of task allocated to the at least one execution unit.

According to embodiments of the present technology, the data processing resource is configured to enable the operation mode of its execution unit(s) to be switched from a normal operation mode to a reduced operation mode, e.g. through the control circuitry controlling the iterator unit, in order to reduce the amount of task (or the size of the workload) allocated to the execution unit(s). When an execution unit is switched to the reduced operation mode, (the control circuitry of) the processing resource proactively reduce the workload to be allocated to the execution unit, such that the time required for the execution unit to complete its workload is reduced, which also leads to a reduction in the power consumption of the execution unit.

In some embodiments, the control circuitry may be configured to switch the operation mode of the at least one execution unit from the normal operation mode to the reduced operation mode upon receiving a stop notification to prepare the at least one execution unit for a stop. Preparing an execution unit for a stop of operation by switching the operation mode of the execution unit to the reduced operation mode leads to a reduction in the time required for the execution unit to complete its workload. As such, the wait for the execution unit to drain its workload in order to complete the stop is reduced. The reduction in waiting time is particularly relevant in a virtualization environment for performing a context switch between two virtual machines. Present embodiments allow the execution unit to operate at a high (or optimal) level while reducing soft stop time by only reducing the operation of the execution unit before a stop is required.

In some embodiments, the control circuitry may be configured to complete the stop on the at least one execution unit to stop an operation of the at least one execution unit upon the at least one execution unit completing all allocated tasks.

In some embodiments, the control circuitry may be configured to power down the at least one execution unit upon completing the stop. In examples where utilization of the processing resource or the execution unit is low, the execution unit operating in the reduced operation mode may be powered down to reduce power consumption.

There may be instances in which a specific execution unit is selected, e.g. for context switch or for powering down, for a soft stop. Thus, in some embodiments, the stop notification may comprise an indication of the at least one execution unit for the stop.

In some embodiments, the control circuitry may be configured to collect utilization data of the one or more execution units, and provide the utilization data of the one or more execution units, e.g. to a system manager.

In some embodiments, upon receiving a power-down notification for a possible power down of the at least one execution unit, the control circuitry may be configured to select the at least one execution unit switched to the reduced operation mode for power down. By switching the operation mode of the execution unit to the reduced operation mode, the time required for the execution unit to complete its workload is reduced, which in turn reduces the wait for the execution unit to drain its workload in order to complete a stop. The reduction in waiting time results in a quicker power down, and, for example, in cases where the control circuitry stops issuing new tasks to the execution unit, the execution unit may already be idle when the power-down notification is received such that the execution unit may be powered down promptly.

In some embodiments, upon receiving a power-down notification for a possible power down of the at least one execution unit, the control circuitry may be configured to monitor the at least one execution unit and override the power-down notification when the at least one execution unit meets one or more override criteria. A power-down notification may be issued, for example by a system (power) manager, when e.g. utilization of (one or more execution units of) the processing resource is declining or fell below a predetermined utilization value. However, after the power-down notification is issued, utilization of (the one or more execution units of) the processing resource may change and/or there may be other reasons against powering down the execution unit, in which case proceeding with powering down the one or more execution units could negatively impact the performance of the processing resource. In that case, (the control circuitry of) the processing resource is configured with the ability to override the power down. In some embodiments, the one or more override criteria comprise an expected increase in utilization, an actual increase in utilization, the execution unit in question being reserved for a dedicated purpose, or a combination thereof. Alternatively, the at least one execution unit of the processing resource does not meet the one or more override criteria, the control circuitry may be configured to power down the at least one execution unit switched to the reduced operation mode.

In some embodiments, the control circuitry may be configured to control the iterator unit to reduce an amount of task allocated to the execution unit by reducing an outstanding task limit associated with the at least one execution unit to limit a number of tasks that can be allocated to the at least one execution unit. Herein, the outstanding task limit to be reduce may be relevant for fragment tasks or compute tasks. By reducing the number of tasks that can be allocated to an execution unit, it is possible for the execution unit to drain its workload/complete all allocated tasks in a shorter time.

In some embodiments, the control circuitry may be configured to control the iterator unit to reduce an amount of task allocated to the execution unit by controlling the iterator unit to stop allocating tasks to the at least one execution unit. Herein, the tasks to be stopped may be fragment tasks or compute tasks. By stopping the allocation of tasks to an execution unit, it is possible for the execution unit to drain its workload/complete all allocated tasks in a shorter time.

In some embodiments, the control circuitry may be configured to control the iterator unit to reduce an amount of task allocated to the execution unit by reducing a size of a task to be allocated to the execution unit. For example, reducing the size of a task may comprise reducing the task increment value of a task to be allocated to an execution unit such that the number of workgroups for the task is reduced. Herein, the task increment value to be reduced may be relevant to compute tasks. By reducing the size of a task to be allocated to the execution unit, the execution unit is able to complete the task allocated to it quicker, and so it is possible for the execution unit to drain its workload/complete all allocated tasks in a shorter time.

In some embodiments, the control circuitry may be configured to control the iterator unit to reduce an amount of task allocated to the execution unit by controlling the iterator unit to reduce a complexity of the one or more tasks to reduce an amount of processing required to perform the one or more tasks. Herein, the tasks of which the complexity is to be reduce may be fragment tasks. By reducing the complexity of the tasks to be allocated to an execution unit, it is possible for the execution unit to drain its workload/complete all allocated tasks in a shorter time.

In some embodiments, the control circuitry may be configured to control the iterator unit to reduce an amount of task allocated to the execution unit by controlling the iterator unit to stop allocating tasks to the execution unit.

Another aspect of the present technology provides a data processing system comprising: a host processor to execute one or more operating systems, each operating system comprising one or more applications; a data processing resource to provide a shared resource for a plurality of the applications; one or more input/output interfaces to submit requests to perform processing jobs to the data processing resource; and a hypervisor to manage allocation of the input/output interfaces to the one or more operating systems, the data processing resource comprising: control circuitry to receive, from the host processor, a request for the data processor unit to perform a processing job; an iterator unit to process the request and generate a workload comprising one or more tasks for the requested processing job; and one or more execution units to perform the one or more tasks, wherein the iterator unit is configured to allocate the one or more tasks to the one or more execution units based on control signals from the control circuitry, wherein, upon receiving a notification of a change in allocation of an input/output interface, the control circuitry is configured to prepare the one or more execution units for a stop by controlling the iterator unit to reduce an amount of task allocated to the one or more execution units.

Embodiments of the present technology are relevant in the implementation of a virtualized environment, especially in relation to context switching between virtual machines for access to the shared processing resource. In particular, by preparing an execution unit of the processing resource for a stop of operation by reducing the amount of task (the size of the workload) to be allocated to the execution unit, it is possible to reduce the time required for the execution unit to complete its workload, and thereby reducing the time required to complete a stop of operation for the execution unit. Present embodiments allow the execution unit to operate at a high (or optimal) performance level while reducing soft stop time by only reducing the operation of the execution unit when a stop is required, such as when a context switch is requested.

In some embodiments, the control circuitry of the data processing resource may be configured to collect utilization data from the one or more execution units and provide the utilization data to the system controller, and the system controller may be configured to monitor the utilization data of the one or more execution units and select the at least one execution unit to be switched to the reduced operation mode when the utilization of the at least one execution unit is declining.

A further aspect of the present technology provides a data processing system comprising: a host processor to execute one or more applications; a data processing resource to perform processing jobs for the one or more applications; and a system controller to manage power consumption of the data processing resource, the data processing resource comprising: control circuitry to receive, from the host processor, a request for the data processor unit to perform a processing job; an iterator unit to process the request and generate a workload comprising one or more tasks for the requested processing job; and one or more execution units to perform the one or more tasks, wherein the iterator unit is configured to allocate the one or more tasks to the one or more execution units based on control signals from the control circuitry, wherein, upon receiving a power down request from the system controller, the control circuitry is configured to switch an operation mode of at least one execution unit from a normal operation mode to a reduced operation mode by controlling the iterator unit to reduce an amount of task allocated to the at least one execution unit.

Embodiments of the present technology are relevant in the context of power management, especially in relation to powering down one or more execution units of a processing resource. In particular, by preparing an execution unit of the processing resource for a stop of operation by reducing the amount of task (the size of the workload) to be allocated to the execution unit, it is possible to reduce the time required for the execution unit to complete its workload, and thereby reducing the time required to complete a stop of operation for the execution unit. In doing so, the time it takes from when a powering down of an execution unit is deemed required to when the execution unit is ready for power down may be reduced, and so overall power consumption is also reduced. Present embodiments allow the execution unit to operate at a high (or optimal) performance level while reducing soft stop time by only reducing the operation of the execution unit when a stop is required, such as when a power down is requested.

A yet further aspect of the present technology provides a method of operating a data processing resource to perform data processing tasks for a host processor, the data processing resource comprising: control circuitry to receive, from the host processor, a request for the data processor unit to perform a processing job; an iterator unit to process the request and generate a workload comprising one or more tasks for the requested processing job; one or more execution units to perform the one or more tasks, wherein the iterator unit is configured to allocate the one or more tasks to the one or more execution units based on control signals from the control circuitry, the method comprising: the control circuitry switching an operation mode of at least one execution unit from a normal operation mode to a reduced operation mode by controlling the iterator unit to reduce an amount of task allocated to the at least one execution unit.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

Embodiments of the present technology thus provides a data processing resource that is configured to enable the operation mode of its execution unit(s) to be switched from a normal operation mode to a reduced operation mode in order to reduce the amount of task (or the size of the workload) allocated to the execution unit(s). When an execution unit is switched to the reduced operation mode, (the control circuitry of) the processing resource proactively reduces the workload to be allocated to the execution unit, such that the time required for the execution unit to complete its workload is reduced, and the power consumption of the execution unit is also reduced. Such a reduction of time in the execution unit completing its workload is particularly relevant when a soft stop (a stop or pause in operation) is required for the execution unit. For example, in the context of virtualized environment in relation to context switching between virtual machines for access to the shared processing resource, by preparing an execution unit of the processing resource for a stop of operation by reducing the amount of task (the size of the workload) to be allocated to the execution unit, it is possible to reduce the time required for the execution unit to complete its workload, and thereby reducing the time required to complete a stop of operation for the execution unit. As another example, in the context of power management in relation to powering down one or more execution units of a processing resource, by preparing an execution unit of the processing resource for a stop of operation by reducing the amount of task (the size of the workload) to be allocated to the execution unit, it is possible to reduce the time required for the execution unit to complete its workload, and thereby reducing the time required to complete a stop of operation for the execution unit such that it can be powered down. Present embodiments allow the execution unit to operate at a high (or optimal) performance level while reducing soft stop time by only reducing the operation of the execution unit when a stop is required, such as when a context switch or power down is requested.

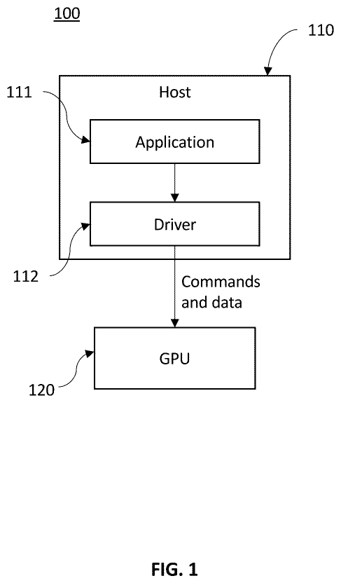

FIG. 1 shows an exemplary data processing system 100 such as a graphics processing system. The data processing system 100 comprises a host processor 110 (e.g. a CPU), which has executing thereon an application 111 (e.g. a game, a web browser) that requires data (e.g. graphics) processing operations to be performed. The data processing system 100 also includes a processing resource such as an accelerator (e.g. graphics processing unit) 120 configured to perform the required data processing operation for the application 111. In response to commands from the application 111 running on the host system 110 for data processing, such as to generate graphics output (e.g. to generate a frame to be displayed), a set of commands is provided to the processing resource 120 to instruct it to perform processing tasks. To this end, the application 111 generates API (application programming interface) calls that are interpreted by a driver 112 for the processing resource 120 running on the host processor 110 to generate appropriate commands to the processing resource 120 to perform the processing tasks, for example to generate graphics output, required by the application 111.

In present embodiments, the commands and data for performing the processing tasks required by the application 111 are provided to the processing resource 120 in the form of one or more command streams, that each include sequences of commands (instructions) to cause the processing resource 120 to perform the desired processing tasks.

The preparation of the command streams is performed by the driver 112 on the host processor 110 and the command streams may, for example, be stored in appropriate command stream buffers (not shown), from where they can then be read by the processing resource 120 for execution.

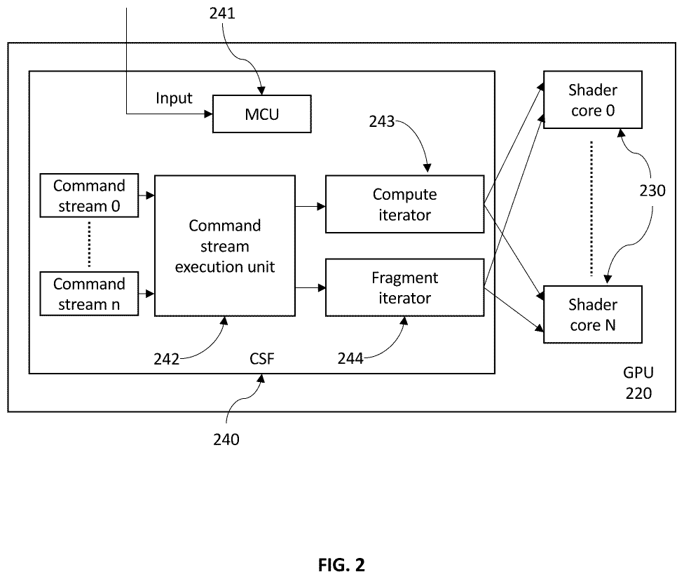

An exemplary processing resource 120 is shown in FIG. 2, implemented as graphics processing unit GPU 220. In the present embodiment, the processing resource 220 is provided with a command stream frontend 240 that includes a command stream supervisor (control circuitry) 241 (e.g. in the form of a microcontroller MCU) that is operable to schedule and issue commands from the command streams (command stream 0, . . . , command stream n) to a command stream execution unit 242. The command stream frontend 240 also includes one or more iterators such as a compute iterator 243 and a fragment iterator 244. More (or fewer) iterators of each or either type, and other types of iterators, are of course possible as desired. The command stream execution unit 242 then executes the commands in the respective command streams, to trigger processing execution units 230 (e.g. shader cores 0, . . . , shader core N) of the GPU 220 to perform the required processing tasks.

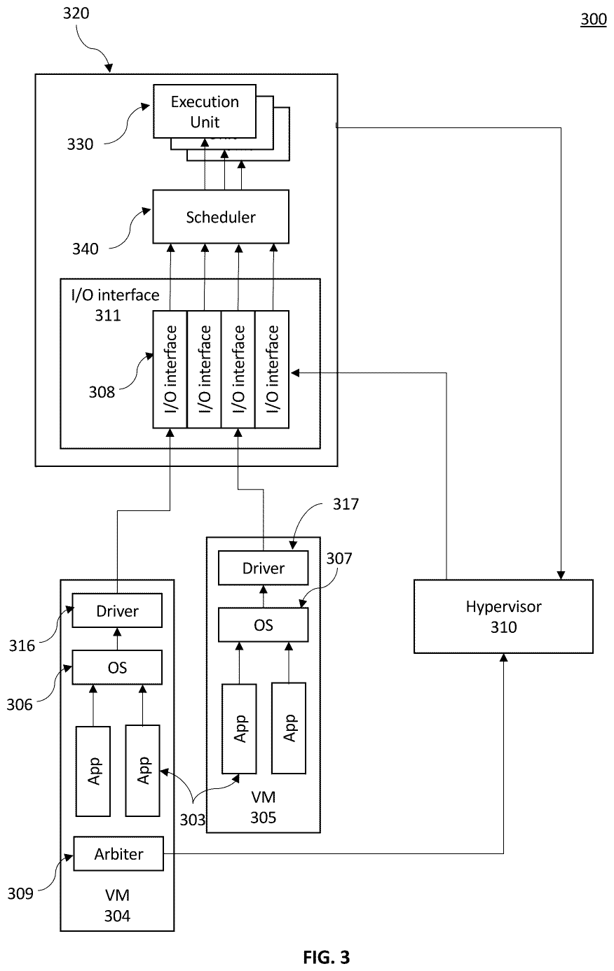

FIG. 3 shows schematically a data processing system 300 in which a processing resource 320 (e.g. an accelerator such as a GPU) that comprises execution units 330 (e.g. shader cores) and a scheduler 340 acts as a common shared processing resource for plural applications (App) 303 executing on respective virtual machines (VM) 304, 305. Each virtual machine 304, 305 comprises a respective operating system (OS) 306, 307 that is executing on a common processor to provide the virtual machines, with respective applications 303 operating within each operating system 306, 307 and a respective driver 316, 317 for generating appropriate commands to the shared processing resource 320 to use the execution units 330.

In order to allow the applications 303 to use the execution units 330 to perform tasks, the execution units 330 have an associated input/output interface module 311 comprising one or more associated input/output interfaces 308 for submitting tasks to the execution units 330, and in which the respective operating systems 306, 307 can store information needed by the execution units 330 when the execution units 330 is to perform a task for a given application. While FIG. 3 shows a system with four sets of input/output interfaces 308, other arrangements are of course possible. As shown in FIG. 3, when an application requires the use of one or more of the execution units 330 to perform a task, it accesses one or more sets of the input/output interfaces 308 of the processing resource 320 via a respective operating system 306, 307.

In the present embodiment, the processing resource 320 comprises scheduler 340 (e.g. iterators 243, 244) that acts to arbitrate amongst and schedule tasks in the input/output interfaces 308. The system 300 also includes a hypervisor 310 that interfaces between the respective virtual machines 304, 305 and the input/output interfaces 308 associated with the processing resource (execution units) 320.

In the present embodiment, the virtual machine 304 further comprises an arbiter 309, making the virtual machine 304 a host virtual machine while the virtual machine 305 may be regarded as a guest virtual machine. Other arrangements, such as to implement the arbiter 309 on the virtual machine 305, to implement the arbiter 309 on the hypervisor 310, etc. are of course possible. Access to the processing resource 320 is time-shared by the virtual machines 304, 305, and the arbiter 309 through the hypervisor 310 uses scheduling statistics (e.g. information regarding the frequency and duration of tasks submitted to and running on the processing resource 320) to manage the allocation of the input/output interfaces 308 to schedule the submission of tasks from the virtual machines 304, 305 to the processing resource 320. The processing resource 320 is thus arranged to send scheduling statistics to the hypervisor 310. The scheduling statistics for the processing resource 320 may include e.g. the number of execution unit idle periods, the number of internal power domain cycles, the number of active clock cycles, etc. The scheduling statistics for each of the virtual machines 304, 305 may include e.g. a flag indicating the general state of the virtual machine input/output interfaces 308, a flag indicating if the virtual machine input/output interfaces 308 has an active task, a flag indicating if the virtual machine input/output interfaces 308 has a pending command or task, a flag indicating if the virtual machine input/output interfaces 308 has a soft-stopped job, the number of cycles with a running fragment task, the number of cycles with a running compute task, etc. It should be noted that the list is not exhaustive and alternative or additional scheduling statistics may be provided.

During operation of the data processing system 300, the hypervisor 310 connects virtual machines 304, 305 to the processing resource 320 via input/output interfaces 308 such that applications 303 running on operating systems 306, 307 on the virtual machines 304, 305 may submit commands for execution on the execution units 330 of the processing resource 320. The virtual machines 304, 305 may each be scheduled for access to the processing resource 320 using time-sliced multiplexing, such that each virtual machine can access the processing resource for a predetermined time period. The virtual machines 304, 305 may also each be assigned a different priority setting for accessing the processing resource 320. Thus, depending on the time-sliced multiplex and/or the relative priority of the tasks being run on the processing resource 320 from the virtual machines 304, 305, and pending tasks to be submitted to the processing resource 320 by other virtual machines, they hypervisor 310 may switch the virtual machines 304, 305 connected to the processing resource 320 (context switch) in order to increase the overall efficiency of the running and pending tasks on the processing resource 320.

To perform a context switch, the hypervisor first needs to identify a virtual machine currently connected to the processing resource 320 that can be disconnected. Using scheduling statistics from the processing resource 320, the hypervisor 310 identifies if there are any virtual machines currently connected to the processing resource 320 that are idle, for example, and so have a lower priority than pending tasks on a virtual machine waiting to be connected. The hypervisor 10 then selects the virtual machine to de-schedule and disconnects it from the processing resource 320, and saves its state to memory so that it can be reconnected, if necessary, at a later time in order to complete the task that had run idle. The hypervisor then connects the waiting virtual machine to the processing resource 320 via an associated input/output interface, so that it can submit pending tasks to the processing resource 320.

Before a context switch can take place for an execution unit 330 of the processing resource 320, a soft stop must be imposed on the execution unit 330 to clear all tasks already scheduled for it before disconnecting one virtual machine and connecting another virtual machine to the execution unit 330 (processing resource 320). Soft stop time of fragment endpoints vary depending on the running content and can be long e.g. for virtualization. A compute job is divided into compute tasks in a compute iterator (e.g. compute iterator 243). Compute tasks consist of workgroups and run time of compute workgroups can vary greatly, and so soft stop time of compute endpoints can be long. Moreover, a GPU may sometimes have its task count increased (to schedule more tasks that there are available number of warp slots) in a shader core to achieve higher utilization (“compute task overpressure”), in which case there may be a high number of tasks scheduled for a shader core when a context switch is planned.

In one aspect, embodiments of the present technology propose to reduce the latency for a soft stop of an execution unit (e.g. a shader core of a GPU, e.g. for context switches) by dynamically adjusting an amount of task to be scheduled to the execution unit.

In particular, an arbitrator such as the hypervisor 310 (e.g. running on a host processor or CPU) may be arranged to notify a processing resource (e.g. processing resource 320) that a context switch is scheduled. Prompted by the notification/request, (the control circuitry 340 of) the processing resource 320 begins to prepare for a soft stop by switching the operation mode of one or more execution units 330 from a normal operation mode to a soft-stop preparation mode (reduced operation mode) to reduce the workload of the one or more execution units 330.

When (the control circuitry of) the processing resource 320 switches one or more execution units 330 to a soft-stop preparation mode (reduced operation mode) to reduce the workload of the one or more execution units 330, one or more actions may be implemented (e.g. by control circuitry 340 through one or more iterators). In one implementation, the number of outstanding tasks in the fragment endpoints may be reduced, e.g. by reducing an outstanding task limit for fragment endpoint, or by preventing the fragment iterator from allocating new tasks to the execution unit. As a crude example for the purpose of illustration only, reducing the task limit from e.g. 4 to 2 tasks may reduce the fragment soft-stop time by ˜40%. Alternatively, or in addition, the number of outstanding tasks in the compute endpoints may be reduced, e.g. by reducing an outstanding task limit for compute endpoint, or by preventing the compute iterator from allocating new tasks to the execution unit. As a crude example for the purpose of illustration only, reducing the task limit from e.g. 16 to 4 tasks may reduce the compute soft-stop time by ˜75%. Alternatively, or in addition, a task increment value may be reduced when an iterator divides a compute job into separate compute tasks, such that each compute task consists of a smaller number of workgroups. Alternatively, or in addition, the complexity of a fragment job may be reduced. Such a change in the operating mode of the processing resource may for example be implemented at a draw call boundary. For example, the processing resource may switch from a DVS (deferred vertex shading) mode to an IDVS (index DVS) mode, and/or vertex shading may be performed earlier and removed from a fragment job.

Through switching the operation mode of an execution unit from normal operation mode to a reduced operation mode to actively reduce the workload allocated to the execution unit, it is possible to reduce the time required to clear/complete all tasks allocated to the execution unit to enable a soft stop. Moreover, by allowing the execution unit to operate in the normal operation mode (with higher utilization) and only switching to the reduced operation mode (with lower utilization) when there is an imminent planned soft stop, utilization of the execution unit can be maintained at a high (optimised) level and the time the execution unit spent operating at low utilization level may be reduced.

As an example, if four VMs are operating on a GPU at 60 fps (frame per second), each VM has a time-slice of 4 ms. Towards the end of its time-slice, a VM is required to yield the GPU, allowing another VM access to the GPU. If the time required to perform a context switch at the GPU is determined to be 300 μs, and the GPU receives a notification for the context switch 100 μs before the scheduled context switch, (the control circuitry of) the GPU may commence the reduced operation mode to prepare for a soft stop upon receiving the notification. In this case, the execution unit(s) of the GPU are only underused (not operating at full capacity) for 100 μs out of the 3.7 ms available operation time within a 4 ms time-slice. It should be noted that the timings are provided for the purpose of illustration only and other arrangements are of course possible.

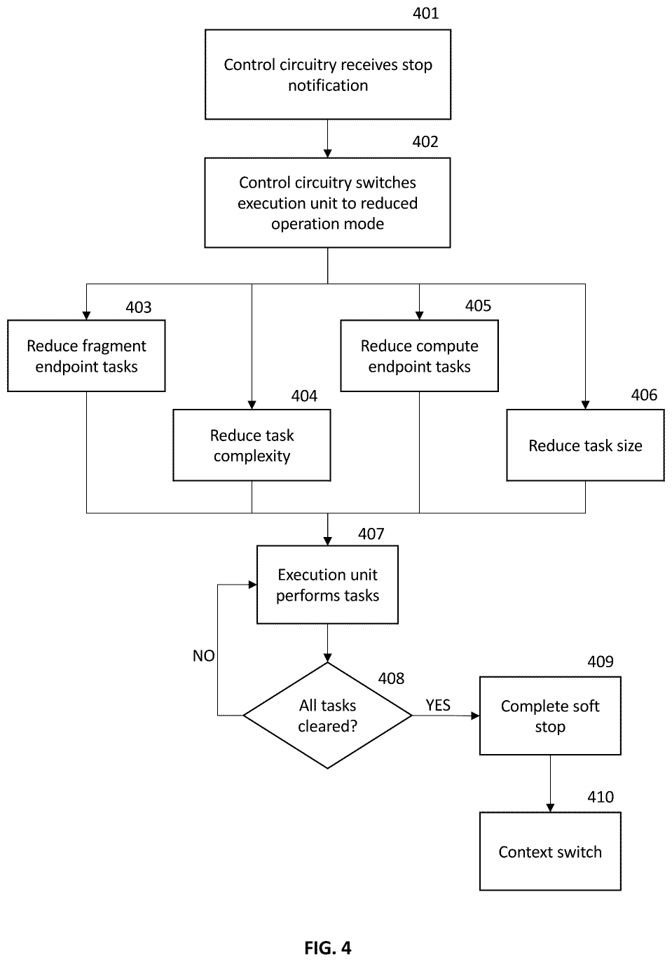

FIG. 4 shows an exemplary method of operating a data processing resource (e.g. data processing resource 320) to perform data processing tasks. The method begins at step 401 when (the control circuitry of) the processing resource receives a notification to notify the processing resource that a soft stop (a temporary stop or pause of operation) is planned for one or more execution units of the processing resource, e.g. in order to perform a context switch for one or more virtual machines connected (to be connected) to the processing resource. In some embodiments, the notification may include information such as a time when the stop (or context switch) is scheduled, an indication of which execution unit(s) the stop (or context switch) is scheduled for, an indication of the virtual machine to disconnect (for a context switch), an indication of the virtual machine to be connected (for a context switch), etc.

Upon receiving the notification, the control circuitry, at step 402, switches the one or more execution units for which a soft stop (or context switch) is planned from a normal operation mode to a reduced operation mode, in which one or more actions are taken to reduce the amount of task allocated (e.g. by one or more iterators of the processing resource) to the one or more execution units. In particular, the one or more actions may include reducing the fragment endpoint tasks (step 403) and/or the compute endpoint tasks (step 405) for the one or more execution units, e.g. by not allocating any new tasks to the one or more execution units or by adjusting/reducing the respective outstanding task limit associated with the one or more execution units to limit the number of tasks that can be allocated to the one or more execution units. The one or more actions may further include reducing the complexity of the tasks when processing upcoming processing jobs to divide each into a plurality of tasks (step 404) and/or reducing the task size of one or more upcoming processing jobs (e.g. compute jobs or fragment jobs), for example by reducing the task increment value for one or more upcoming compute jobs to reduce the number of workgroups for each compute task and/or reducing the tile size for one or more upcoming fragment jobs (step 406).

At step 407, the one or more execution units for which a soft stop is planned continue to perform the processing tasks allocated to them (step 408, NO branch) until all allocated tasks scheduled for the respective one or more execution units have been completed. When all allocated tasks are cleared for a given execution unit (step 408, YES branch), a soft stop (or pause) is imposed on that execution unit (step 409) to temporarily stop the operation of the execution unit. When the soft stop is in place, a context switch is performed (step 410) to disconnect a virtual machine connected to the execution unit and connect a different virtual machine to the execution unit.

In an implementation example, embodiments of the present technology may be implemented in automotive processors in vehicles. For example, an automotive processor may be required to perform a range of different functionalities, such as information, entertainment, safety function, etc. An automotive processor may be running a virtual machine and sometimes be required to disconnect the virtual machine e.g. in order to run a built-in self-test on the hardware to meet functional safety requirements. Then after completing the test, the virtual machine is reconnected. The present technology may therefore be applicable to automotive processors.

In an alternative, or additional, embodiment, the arbiter 309 (whether within the host virtual machine 304 or other arrangements in which the arbiter is implemented elsewhere) may also (alternatively) use the scheduling statistics to determine the optimum dynamic voltage and frequency scaling (e.g. running DVFS/DCS code) point at which to operate the processing resource 320 in order to minimize its power consumption. For example, the information regarding usage of the processing resource by the virtual machines, e.g. the fraction of time a resource (execution unit) is used, may be used to control the frequency of the processing resource (GPU), which affects the future available capacity of the processing resource. The temperature of the processing resource and the frequency of other parts of the data processing system, for example, may also be used to influence the decision on frequency for the processing resource. For example, if the scheduling statistics indicate that the usage of (one or more execution units of) the processing resource is low, its frequency may be reduced such that (the one or more execution units of) the processing resource still performs at an acceptable level (providing sufficient processing capacity to the virtual machines connected thereto) while minimizing/reducing its power consumption.

In this embodiment, the processing resource may select one or more execution units (e.g. execution units showing low utilization) to switch to the reduced operation mode, for example when overall utilization of the processing resource is low. In this case, if utilization of the processing resource continues to fall, the one or more execution units operating in the reduced operation mode may be powered down, first by completing all allocated tasks then come to a soft stop, to further reduce power consumption.

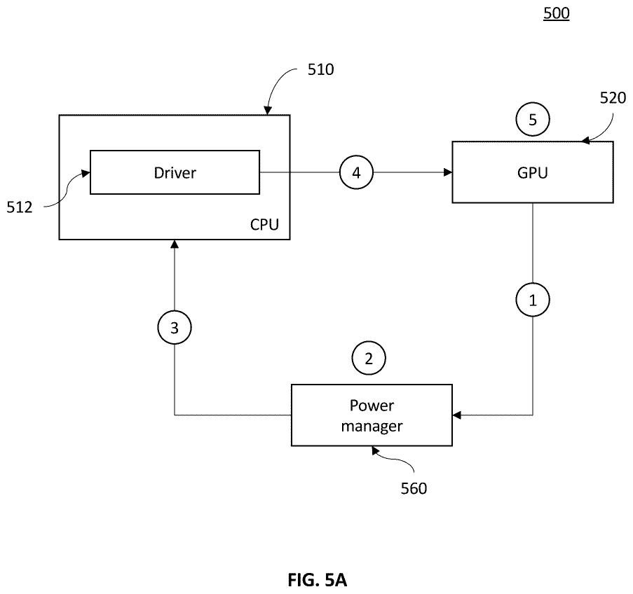

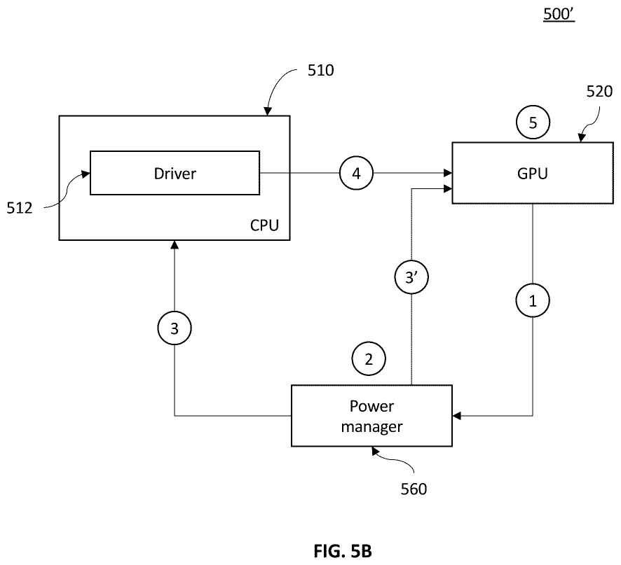

Power management methods in which one or more execution units (e.g. shader cores) of a processing resource (e.g. GPU) are powered down to reduce power consumption are not limited to virtualization implementations. For example, GPU firmware may identify one or more shader cores that have been idle for a predetermined period of time, and conserve power by powering these idle cores off, as shown in FIG. 5A. Powering down idle cores also provides a way of controlling temperature of the shader cores to avoid or reduce the likelihood of reaching or exceeding a thermal limit.

FIG. 5A schematically shows an exemplary power management control loop 500 for a GPU shader core:
1. A power manager 560 (e.g. a system control processor SCP) received performance statistics (e.g. utilization figures, operating temperature) from the GPU 520;
2. The power manager 560 determines (e.g. by running DVFS/DCS code) a target voltage and a target frequency using the performance statistics to optimize (minimize) the power consumption of the GPU 520 and determines an active core mask based on the target voltage and frequency that specifies the shader cores to remain active (and the shader cores to power down);
3. The power manager 560 communicates changes, if any, in the target voltage and frequency to the CPU 510, e.g. through SCMI protocol;
4. The CPU 510 propagates the request from the power manager 560 by programming the active core mask, via an associated driver 512, in the GPU 520 through the CSF host interface of the GPU 520; and
5. The GPU 520 firmware takes the necessary action to power on or off shader cores based on the received active core mask.

All the events that take place between the generation of the performance statistics to the active core mask being propagated the GPU 520 (steps 2, 3 and 4) can incur long delays, especially the step of programming the active core mask and propagating it to the GPU 520 (step 4). When the GPU firmware eventually receives the power-down request, it begins the power down procedure by performing a soft stop on the specified shader core(s). Each event leading up to power down takes place sequentially and the accumulated delay of all individual events determines the time it takes to power down a shader core. In a virtualized environment (e.g. where the GPU is shared amongst plural virtual machines), additional delays may incur on the messaging passing path, in that the arbiter (hypervisor) will receive the power-down request and must propagate the request by sending a message to the VM (out of the plural virtual machines) that is currently accessing the GPU.

Adding to the overall delay, there may be a long wait before a shader core can be switched off (powered down/off) as a soft stop must complete before powering down the shader core. When performing a soft stop, the workload allocated to the shader core must be drained (all tasks completed), and this can take a long time if the shader core has a high workload. Embodiments of the present technology thus provides a reduced operation mode for shader cores (execution units), for example when a shader core is selected as a candidate for powering down. Shader cores that are operating under the reduced operation mode are capable of completing a soft stop in a shorter time. In an embodiment, the GPU (processing resource) may be configured such that the shader core power manager 560 is able to control the shader cores, e.g. via the control circuitry of the GPU 520, to switch one or more shader cores to the reduced operation mode.

FIG. 5B shows an exemplary power management flow 500′ according to an embodiment:
1. The power manager 560 (e.g. a system control processor SCP) received performance statistics (e.g. utilization figures, operating temperature) from the GPU 520;
2. The power manager 560 determines (e.g. by running DVFS/DCS code) a target voltage and a target frequency using the performance statistics to optimize (minimize) the power consumption of the GPU 520 and determines an active core mask based on the target voltage and frequency that specifies the shader cores to remain active (and the shader cores to power down);
3. The power manager 560 communicates changes, if any, in the target voltage and frequency to the CPU 510, e.g. through SCMI protocol;
3′. Based on the active core mask, the power manager 560 programs a proposed reduced mode core mask in the GPU that specifies one or more shader cores to be switched to a reduced operation mode and notifies the GPU of a possible power down of one or more cores;
4. The CPU 510 propagates the request from the power manager 560 by programming the active core mask, via an associated driver 512, in the GPU 520 through the CSF host interface of the GPU 520 (this step overlaps with the draining of tasks in selected shader cores switched to the reduced operation mode); and
5. The GPU 520 firmware takes the necessary action to power on or off shader cores based on the received active core mask-shader cores switched to the reduce operation made can either be much quicker at completing a soft stop or already completed a soft stop.

The reduced operation mode may include taking one or more actions to proactively prepare a shader core for a power off request. In one implementation, the number of outstanding tasks in the fragment endpoints may be reduced, e.g. by reducing an outstanding task limit for fragment endpoint, or by preventing the fragment iterator from allocating new tasks to the execution unit. Alternatively, or in addition, the number of outstanding tasks in the compute endpoints may be reduced, e.g. by reducing an outstanding task limit for compute endpoint, or by preventing the compute iterator from allocating new tasks to the execution unit. Alternatively, or in addition, a task increment value may be reduced when an iterator divides a compute job into separate compute tasks, such that each compute task consists of a smaller number of workgroups. Alternatively, or in addition, the complexity of a fragment job may be reduced.

In addition to faster soft stop that can lead to a faster power down, while information regarding power management is being passed between the power manager 560, the CPU 510, and the GPU 520, operating at least some of the shader cores in the reduced operation mode is conserving power by reducing switching activity in these shader cores.

In an implementation example, a shader core operating in the reduced operation mode may have the number of compute tasks reduced e.g. from 16 to 4, i.e. not applying compute overpressure. In addition, or alternatively, the number of tasks in the fragment endpoint can be reduced from 4 to 2. In doing so, soft stop time can be reduced significantly while having a low impact on the performance as either action still maintains a good utilization of warp slots in the GPU.

In another implementation example, warp utilization may be disregarded in favor of not issuing new tasks to shader cores operating in the reduced operation mode. In this case, the shader cores operating in the reduced operation mode are expected to reach soft stop before power-down information is communicated the power manager 560 through the CPU 510 to the GPU 520 (steps 3 to 5), such that when the power-down request reaches the GPU 520, the shader cores operating in the reduced operation mode are already idling and can power down immediately.

In short, when a shader core is switched to the reduced operation mode, its workload is reduced such that a subsequent soft-stop request can be completed faster. In examples where the reduced operation mode is implemented by stopping issuing tasks to the selected shader core(s), this can lead to the completion of a soft stop before the GPU receives a power-down request. In such implementations, while waiting for the host CPU to take the necessary action and communicate a power-off request to the GPU, shader cores switched to the reduced operation mode may already be idle. Idle cores have minimal switching activity which conserve dynamic power.

In the above embodiments, while it is possible for the GPU driver 512 to directly control the power management of the shader cores of the GPU 520, such control is assigned to the firmware of the GPU 520. Since GPU firmware is able to identify idle shader cores, it is more suited for identifying candidate shader cores for powering off. Moreover, GPU firmware may be aware of shader cores being used for dedicated purposes that may be unknown to the CPU 510, such as, for example, a proportion of the shader cores may be assigned as “reserved for compute” that give compute tasks a higher priority, or where there are plural iterators of the same type, one or more shader cores may be assigned to a specific iterator. In this case, a power-down request from an external control (e.g. power manager 560) without insight to the inner working of the GPU 520 may sometimes be unsuitable or inefficient for the operation of the GPU 520. As such, it may be desirable to enable the GPU firmware to process the requested active core mask information and make the final decision whether, and which shader core(s), to power off.

In a further embodiment, the GPU (processing resource) is configured to be in control of a shader core power-down request, and able to disregard the request (or part of the request) to power down one or more shader cores. In the present embodiment, the GPU may disregard the power-down notification and override the proposed reduced mode specified by the power manager 560 for one or more shader cores, and switch one or more shader cores back from the reduced operation mode to the normal operation mode.

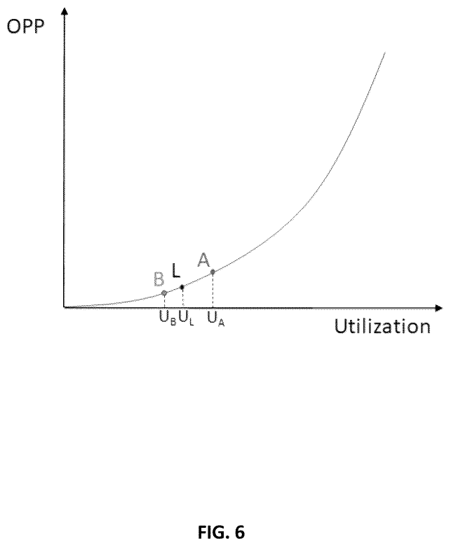

In an example, FIG. 6 shows an operating performance point (OPP) curve. At time instance t0, the GPU reports a low utilization figure UA and the GPU is running at a low OPP (A).

At time instance t1, the GPU reports a lower utilization figure UL and the GPU is running at an even low OPP (L), but the utilization figure is not sufficiently low to power down any shader cores. A further reduction in utilization may lead to a shader core being powered down, as keeping this shader cores powered up consumes higher leakage power compared to its dynamic power.

At time instance t2, the GPU utilization drops to an even lower utilization figure U_{B} and the GPU is now running at the predetermined OPP (B) for powering down at least one shader core.

In previous approaches, the shader core power manager would wait until GPU utilization drops to U_{B} before requesting one or more shader cores to be powered off. If GPU utilization begins to rise again, then the shader core power manager would request the cores to be powered up again. The shader core power manager the apples a hysteresis when powering off and on shader cores.

In the present embodiment, it may be arranged such that the GPU (or the power manager) may switch one or more shader cores to the reduced operation mode when GPU utilization reaches an intermediate OPP L. Thus, when GPU utilization figure reaches U_{L}, the GPU switches one or more shader cores to the reduced operation mode. Then, when GPU utilization figure is next sample, the impact of switching the one or more shader cores to the reduced operation mode can be seen (e.g. utilization continues to fall to U_{B} or rises to or above U_{A}). Using the subsequent reading(s) of utilization figure, the GPU may determine to comply with a power-down request to power down a shader core (operating in the reduced operation mode or idle) if utilization figure continues to drop, or switch one or more shader cores operating in the reduced operation mode back to the normal mode if utilization figure rises.

If the GPU already operates at a reduced voltage and frequency point and its utilization remains low, dynamic core scaling (DCS) algorithm (running on the power manager) can decide to power down one or more shader cores (e.g. if static power>dynamic power). In this scenario, before requesting the GPU to power down a core, the DCS algorithm can make a stepwise decision. First, the power manager may first switch the core to the reduced operation mode. Then, the power manager may check the updated utilization figure. DCS algorithm may then confirm, using the updated utilization figure, that the core should be powered down. Once the decision to power down the core is made, the reduced amount of workload in the core, having been switched to the reduced operation mode, can be significantly faster compared to a fully loaded shader core.

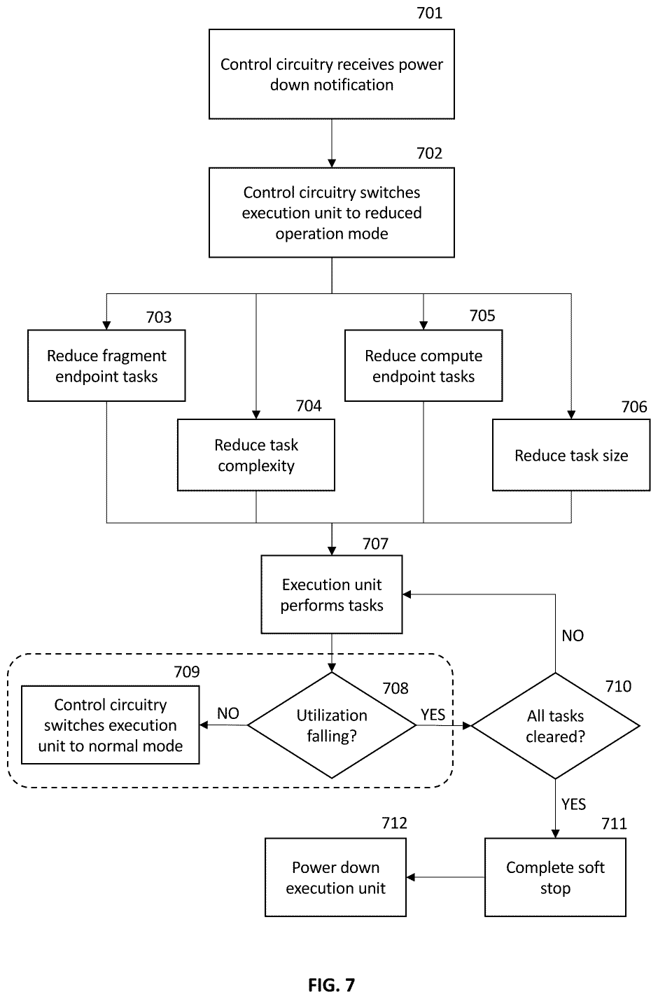

FIG. 7 shows another exemplary method of operating a data processing resource to perform data processing tasks.

The method begins at step 701 when (the control circuitry of) the processing resource receives a power-down notification (e.g. active core mask, reduced mode core mask) of a possible or planned power down of one or more execution units of the processing resource, e.g. to reduce power consumption and/or to regulate operating temperature. In the present embodiment, the power-down notification in effect notifies the processing resource that a soft stop (a temporary stop or pause of operation) is planned for one or more execution units.

Upon receiving the power-down notification, the control circuitry, at step 702, switches the one or more execution units for which power down is notified from a normal operation mode to a reduced operation mode, in which one or more actions are taken to reduce the amount of task allocated (e.g. by one or more iterators of the processing resource) to the one or more execution units.

In some embodiments, step 702 may be initiated by a fall in utilization detected in (one or more execution units of) the processing resource e.g. by the power manager 560, for example when utilization drops below a threshold (e.g. intermediate utilization figure UL).

The one or more actions may include reducing the fragment endpoint tasks (step 703) and/or the compute endpoint tasks (step 705) for the one or more execution units, e.g. by not allocating any new tasks to the one or more execution units or by adjusting/reducing the respective outstanding task limit associated with the one or more execution units to limit the number of tasks that can be allocated to the one or more execution units. The one or more actions may further include reducing the complexity of the tasks when processing upcoming processing jobs to divide each into a plurality of tasks (step 704) and/or reducing the task size of one or more upcoming processing jobs (e.g. compute jobs or fragment jobs), for example by reducing the task increment value for one or more upcoming compute jobs to reduce the number of workgroups for each compute task and/or reducing the tile size for one or more upcoming fragment jobs (step 706).

At step 707, the one or more execution units that are switched to the reduced operation mode continue to perform the processing tasks allocated to them.

In some embodiments, (the control circuitry of) the processing resource collects the utilization figures/data of the one or more execution units and provides the utilization figures/data of the one or more execution units for monitoring e.g. by the power manager 560 (step 708). If utilization remains steady or rises (NO branch of step 708), (the control circuitry of) the processing resource is configured, in these embodiments, to override or disregard the power-down notification and switch some or all of the one or more execution units back to the normal operation mode. If utilization continues to decline (YES branch of step 708), the processing resource proceeds with preparing the one or more execution units for power down. The dashed line denotes the steps of 708 and 709 as optional; in other embodiments, steps 708 and 709 may be omitted. In some embodiments, (the control circuitry of) the processing resource is configured to monitor the at least one execution unit, and override the power-down notification when the at least one execution unit meets one or more override criteria. For example, the one or more override criteria may include an expected increase in utilization of one or more execution units or an actual increase in utilization, or, in some cases, an execution unit may be reserved for a dedicated purpose and therefore powering down is undesirable and/or may affect the performance of the processing resource.

If the one or more execution units do not meet the one or more override criteria, the processing resource continues to wait for the one or more execution units to complete all allocated tasks (step 710, NO branch). When all allocated tasks are cleared for a given execution unit (step 710, YES branch), (the control circuitry of) the processing resource completes a soft stop (or pause) in the execution unit (step 711) to stop the operation of the execution unit. Following the completion of the soft stop, the execution unit may be powered down at step 712.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A data processing resource for performing data processing tasks for a host processor, the data processing resource comprising:
control circuitry to receive, from the host processor, a request for the data processor unit to perform a processing job;
an iterator unit to process the request and generate a workload comprising one or more tasks for the requested processing job;
one or more execution units to perform the one or more tasks, wherein the iterator unit is configured to allocate the one or more tasks to the one or more execution units based on control signals from the control circuitry,
wherein the control circuitry is further configured to switch an operation mode of at least one execution unit from a normal operation mode to a reduced operation mode by controlling the iterator unit to reduce an amount of task allocated to the at least one execution unit.

2. The data processing resource of claim 1, wherein the control circuitry is configured to switch the operation mode of the at least one execution unit from the normal operation mode to the reduced operation mode upon receiving a stop notification to prepare the at least one execution unit for a stop.

3. The data processing resource of claim 2, wherein the control circuitry is configured to complete the stop on the at least one execution unit to stop an operation of the at least one execution unit upon the at least one execution unit completing all allocated tasks.

4. The data processing resource of claim 3, wherein the control circuitry is configured to power down the at least one execution unit upon completing the stop.

5. The data processing resource of claim 2, wherein the stop notification comprises an indication of the at least one execution unit for the stop.

6. The data processing resource of claim 1, wherein the control circuitry is configured to collect utilization data from the one or more execution units and provide the utilization data of the one or more execution units.

7. The data processing resource of claim 1, wherein upon receiving a power-down notification for a possible power down of the at least one execution unit, the control circuitry is configured to select the at least one execution unit switched to the reduced operation mode for power down.

8. The data processing resource of claim 1, wherein upon receiving a power-down notification for a possible power down of the at least one execution unit, the control circuitry is configured to monitor the at least one execution unit and override the power-down notification when the at least one execution unit meets one or more override criteria.

9. The data processing resource of claim 8, wherein the one or more override criteria comprise an expected increase in utilization, an actual increase in utilization, the execution unit in question being reserved for a dedicated purpose, or a combination thereof.

10. The data processing resource of claim 8, wherein the control circuitry is configured to power down the at least one execution unit switched to the reduced operation mode when the at least one execution unit does not meet the one or more override criteria.

11. The data processing resource of claim 1, wherein the control circuitry is configured to control the iterator unit to reduce an amount of task allocated to the execution unit by reducing an outstanding task limit associated with the at least one execution unit to limit a number of tasks that can be allocated to the at least one execution unit.

12. The data processing resource of claim 1, wherein the control circuitry is configured to control the iterator unit to reduce an amount of task allocated to the execution unit by controlling the iterator unit to stop allocating tasks to the at least one execution unit.

13. The data processing resource of claim 1, wherein the control circuitry is configured to control the iterator unit to reduce an amount of task allocated to the execution unit by reducing a size of a task to be allocated to the execution unit.

14. The data processing resource of claim 1, wherein the control circuitry is configured to control the iterator unit to reduce an amount of task allocated to the execution unit by controlling the iterator unit to reduce a complexity of the one or more tasks to reduce an amount of processing required to perform the one or more tasks.

15. A data processing system comprising:
a host processor to execute one or more operating systems, each operating system comprising one or more applications;
a data processing resource to provide a shared resource for a plurality of the applications;
one or more input/output interfaces to submit requests to perform processing jobs to the data processing resource;
the data processing resource comprising:
control circuitry to receive, from the host processor, a request for the data processor unit to perform a processing job;
an iterator unit to process the request and generate a workload comprising one or more tasks for the requested processing job;
one or more execution units to perform the one or more tasks, wherein the iterator unit is configured to allocate the one or more tasks to the one or more execution units based on control signals from the control circuitry,
wherein, upon receiving a notification of a change in allocation of an input/output interface, the control circuitry is configured to prepare the one or more execution units for a stop by controlling the iterator unit to reduce an amount of task allocated to the one or more execution units.

16. A data processing system comprising:
a host processor to execute one or more applications;
a data processing resource to perform processing jobs for the one or more applications; and
a system controller to manage power consumption of the data processing resource,
the data processing resource comprising:
control circuitry to receive, from the host processor, a request for the data processor unit to perform a processing job;
an iterator unit to process the request and generate a workload comprising one or more tasks for the requested processing job;
one or more execution units to perform the one or more tasks, wherein the iterator unit is configured to allocate the one or more tasks to the one or more execution units based on control signals from the control circuitry,
wherein, upon receiving a power down request from the system controller, the control circuitry is configured to switch an operation mode of at least one execution unit from a normal operation mode to a reduced operation mode by controlling the iterator unit to reduce an amount of task allocated to the at least one execution unit.

17. The data processing system of claim 16, wherein
the control circuitry of the data processing resource is configured to collect utilization data from the one or more execution units and provide the utilization data to the system controller; and
the system controller is configured to monitor the utilization data of the one or more execution units and select the at least one execution unit to be switched to the reduced operation mode when the utilization of the at least one execution unit is declining.

18. A method of operating a data processing resource to perform data processing tasks for a host processor, the data processing resource comprising:
control circuitry to receive, from the host processor, a request for the data processor unit to perform a processing job;
an iterator unit to process the request and generate a workload comprising one or more tasks for the requested processing job;
one or more execution units to perform the one or more tasks, wherein the iterator unit is configured to allocate the one or more tasks to the one or more execution units based on control signals from the control circuitry,
the method comprising:
the control circuitry switching an operation mode of at least one execution unit from a normal operation mode to a reduced operation mode by controlling the iterator unit to reduce an amount of task allocated to the at least one execution unit.

19. The method of claim 18, wherein the control circuitry switches the operation mode of the at least one execution unit from the normal operation mode to the reduced operation mode upon receiving a stop notification to prepare the at least one execution unit for a stop.

20. The method of claim 19, further comprising the control circuitry completing the stop on the at least one execution unit to stop an operation of the at least one execution unit upon the at least one execution unit completing all allocated tasks, and optionally further comprising the control circuitry powering down the at least one execution unit upon completing the stop.
